(19) United States
(12) Patent Application Publication
(10) Pub. No.: US 2002/0169731 A1
(43) Pub. Date: Nov. 14, 2002

(54) Television programming recommendations through generalization and specialization of program content

(75) Inventors: Srinivas Gutta, Buchanan, NY (US); Kaushal Kurapati, Yorktown Heights, NY (US)

Correspondence Address: Michael E. Marion, Corporate Patent Counsel, U.S. Philips Corporation, 580 White Plains Road, Tarrytown, NY, 10591, US

(73) Assignee: Koninklijke Philips Electronics N.V.

(21) Appl. No.: 09/794,445

(22) Filed: Feb. 27, 2001

(51) Int. Cl. G06F 15/18

(52) U.S. Cl. 706/25

(57) ABSTRACT

A method for learning a concept description from an example set containing a plurality of positive and/or negative examples. The method including the steps of: initializing a general set to contain a null concept description; initializing a specific set to contain a concept description of a first positive example from the example set; and making the specific set more general according to each additional positive example from the example set and making the general set more specific according to each additional negative example from the example set until the specific and general sets converge to a single concept description. Preferably, the plurality of positive and negative examples contain description regarding television programming of a viewer and the concept description indicates a type of television programming the viewer likes.

### BACKGROUND OF THE INVENTION

1. Field of the Invention

The present invention relates generally to a method and apparatus for recommending television programming, and more particularly to, recommending television programming through generalization and specialization of program content.

2. Prior Art

Techniques like Bayesian classifiers and decision trees have been used for making TV recommendations through implicit means. Both Bayesian classifiers and decision trees are based on computing the frequency count of a particular feature appearing in the viewer's view history. Other techniques like nearest neighbor classifiers rather than working on the features, transform the feature space into numerical representation and then compute likeness via distance measures.

While these methods have their advantages, the results obtained therefrom are not easily stored or modified. Furthermore, the learning methods of the prior art are not least-commitment methods. That is, even if all positive examples contain a certain variable, the learning methods of the prior art may reject the possibility that the target concept may include another variable even though not positively reinforced by a negative example.

### SUMMARY OF THE INVENTION

Therefore it is an object of the present invention to provide a learning method which overcomes the disadvantages of the learning methods of the prior art.

As opposed to the prior art learning methods, an alternative learning scheme is provided which is based on a version space or candidate elimination. The version space methods of the present invention work on a history of positive and negative examples, such as TV program content information, directly by applying repeated generalization and specialization operators so that the concept description thus obtained is consistent with all the positive examples and inconsistent with the negative examples. In other words, the learning methods of the present invention repeatedly specialize and generalize so that the target object becomes one with the current object.

Accordingly, a method for learning a concept description from an example set containing a plurality of positive and/or negative examples is provided. The method comprises the steps of: initializing a general set to contain a null concept description; initializing a specific set to contain a concept description of a first positive example from the example set; and making the specific set more general according to each additional positive example from the example set and making the general set more specific according to each additional negative example from the example set until the specific and general sets converge to a single concept description.

Also provided is a preferred implementation of a method for learning a concept description from an example set containing a plurality of positive and/or negative examples. The preferred method comprises the steps of: (a) initializing a general set to contain a null concept description; (b) initializing a specific set to contain a concept description of a first positive example from the example set;(c) accepting a next example from the plurality of positive and/or negative examples; if the next example is a positive example: removing from the concept description of the general set any description that does not cover the next example; and updating the concept description of the specific set to contain the most specific set of descriptions that covers both the next example and the concept description before it is updated; (d) if the next example is a negative example: removing from the concept description of the specific set any description that covers the next example; and updating the concept description of the general set to contain the most general set of descriptions that do not cover the next example; and (e) repeating steps (c) and (d) until either each of the specific and general sets contain a single concept description which is the same or until each of the specific and general sets contain a single concept description which is different.

Preferably, where step (e) results in the single concept description which is the same, the method further comprises the step of (f) outputting the single concept description which is the same.

Preferably, the plurality of positive and negative examples contain description regarding television programming of a viewer and the single concept description which is the same resulting from step (e) indicates a type of television programming the viewer likes. More preferably, the single concept description which is the same is output to a television recording device for automatically recording television programs which fit the single concept description.

Still yet provided are a program storage device readable by machine, tangibly embodying a program of instructions executable by the machine to perform the method steps of the present invention and a computer program product embodied in a computer-readable medium for learning a concept description which comprises computer readable program code means for carrying out the method steps of the present invention.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a schematical representation of a concept and a version space utilized in the learning methods of the present invention.

FIG. 2 illustrates a flow chart showing the steps of the learning methods of the present invention.

### DETAILED DESCRIPTION OF THE PREFERRED EMBODIMENT

Although this invention is applicable to numerous and various types of learning tasks, it has been found particularly useful in the environment of television programming. Therefore, without limiting the applicability of the invention to television programming, the invention will be described in such environment.

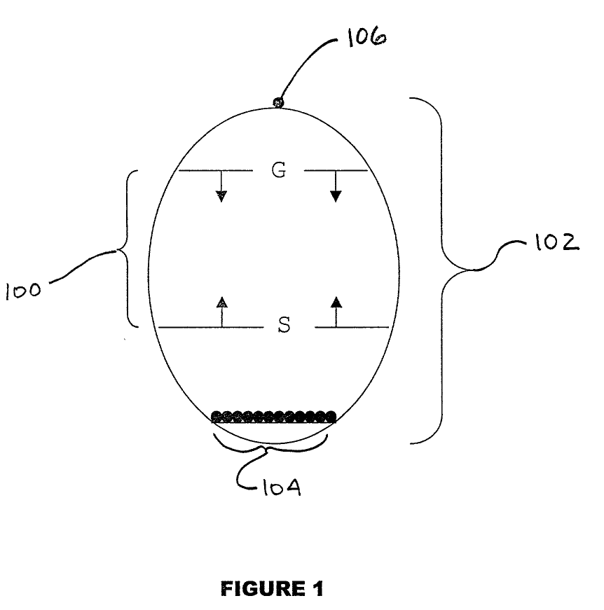

The learning methods of the present invention can be summarized with reference to FIG. 1, which illustrates a version space 100 consisting of two subsets of a concept space 102. One subset referred to as G, contains the most general descriptions consistent with training examples 104 seen at any given point in time. The other subset, referred to as S, contains the most specific descriptions consistent with the training examples 104. Thus, the version space 100 is the set of all descriptions that lie between some element of G and some element of S in the partial order of the concept space 102. Each time a positive training example is received, the S set is made more general. Negative training examples serve to make the G set more specific. If the S and G sets converge, the range of hypotheses will narrow to a single concept description.

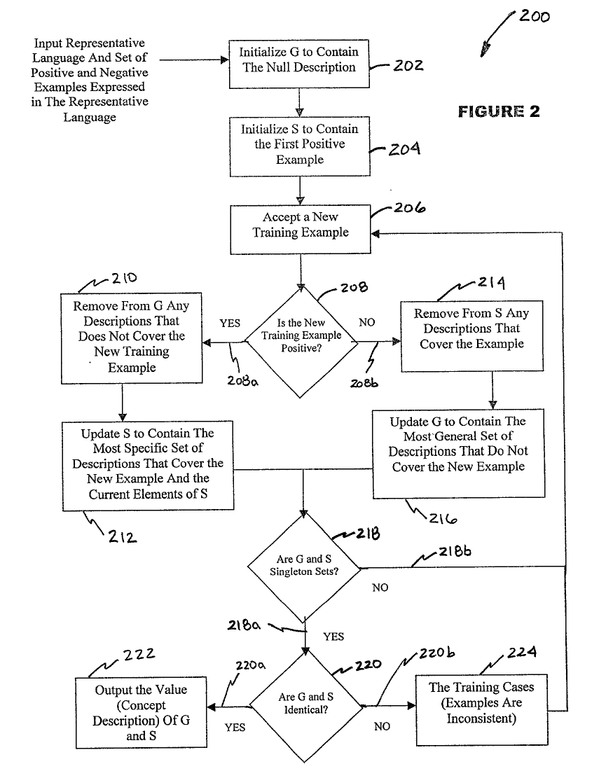

The learning methods of the present invention will now be described in detail with reference to the flowchart of FIG. 2 wherein the learning methods of the present invention are generally referred to by reference numeral 200. The learning methods of the present invention input a representation language and a set (view history) of positive and negative examples expressed in that language and computes a concept description that is consistent with all the positive examples and none of the negative examples.

At step 202, G is initialized to contain one element, the null description (106 in FIG. 1) in which all features are variables. At step 204, S is initialized to contain one element, the first positive example (or random seed). At step 206, a new training example is accepted. It is then decided if the new training example is positive or negative at step 208. If the new training example is a positive example, the flowchart proceeds along path 108a to step 210 where any descriptions that do not cover the new training example are removed from G. After which, the S set is updated at step 212 to contain the most specific set of descriptions in the version space 200 that cover the example and the current elements of the S set. In other words, the elements of S are generalized as little as possible so that they cover the new training example.

If the new training example is a negative example, the flowchart proceeds along path 208b to step 214 where any descriptions that cover the example are removed from S. After which, the G set is updated at step 216 to contain the most general set of descriptions in the version space 200 that do not cover the example. In other words, elements of G are specialized as little as possible so that the negative example is no longer covered by any of the elements of G.

It is then determined if S and G are both singleton sets at step 218. S and G are singleton sets when they each contain only a single concept description. If they are singleton steps, the flowchart proceeds along path 218a to step 220 where it is determined if S and G are identical. If S and G are not singleton sets, meaning they have not converged, then the method loops to step 206 where another training example is accepted.

If it is determined that S and G are identical, the flowchart proceeds along path 220a to step 222 to output the their value which is the concept description which is consistent with all the positive examples and none of the negative examples. If S and G are both singleton sets but they are different, the flowchart proceeds along path 220b to step 224 where it is determined that the training cases (examples) are inconsistent. At this point the result can be output and the method stopped or the method can proceed along path 218b and loop back to step 206 to accept further training examples.

Thus, in step 220 above, if both S and G are identical, then it implies that the algorithm has converged and it also means that a concept description has been learned that is consistent with all the positive examples and none of the negative examples of the training set (view history). If on the other hand, S and G are not identical, it means that there are two concept descriptions representing the concept that is being learnt (in this case, liked vs. disliked). The negative examples thus covered by the concept would be deemed to be the error rate.

Those skilled in the art will appreciated a distinct advantage of the learning methods of the present invention over the methods of the prior art, namely, the version space is completely incremental and thus an efficient scheme for storage and modification. Once the concept description is learnt, the training set can be discarded.

### EXAMPLE

The learning methods of the present invention will now be described by way of an example directed to television programming. However, those skilled in the art will appreciate that television programming is given by way of example only and not to limit the scope and spirit of the present invention. The learning methods of the present invention can be used in many other areas, such as credit monitoring and insurance analysis.

For the sake of simplicity, only TV programs pertaining to movies will be considered in this example. However, it will be appreciated by those in the art that other types of programs, such as sports, live events, sitcoms, etc. can also be considered by the learning methods of the present invention.

The following is given as the representative language for a sample set of movies:

The origin of the movie, such as USA, Britain, Canada, France, or Germany; the producer of the movie, such as FOX, NBC, ABC, or UPN; the rating of the movie, such as R, PG, PG 13, or F; the decade in which the movie was made, such as 1950, 1960, 1970, 1980, 1990, or 2000; and the type of movie, such as Comedy, Action, Suspense, or Family.

The following is also given as the set of positive and negative examples from the view history (in the order of origin, producer, rating, decade, and type. Furthermore, a positive sign (+) indicates a positive example (e.g., it is judged to be favorable by a viewer) and a negative sign (−) indicates a negative example (e.g., it is judged not to be favorable by a viewer):

(1) USA, FOX, PG, 1970, Comedy, +

(2) USA, NBC, R, 1980, Action, −

(3) USA, NBC, PG, 1990, Comedy, +

(4) Britain, UPN, PG 13, 1970, Comedy, −

(5) USA, FOX, F, 1970, Comedy, +

Suppose it is desired to learn the concept of “what movies the user likes” from the above set of positive and negative examples. G and S are both singleton sets. G is initialized with a the null description, while S is initialized to contain the first positive example. The version space then contains all descriptions that are consistent with the first example.

G={(x1, x2, x3, x4, x5)}

S={(USA, FOX, PG, 1970, Comedy)}

Where x1 is origin, x2 is producer, x3 is rating, x4 is decade, and x5 is type.

The second example is a negative one. Thus, the G set must be specialized in such a way that the second negative example is no longer in the version space. In the representation language shown above, specialization preferably involves replacing variables with constants. Thus, the G set must be specialized only to descriptions that are within the current version space but not outside it. The possible specialization's are:

G={(x1, FOX, x3, x4, x5), (x1, x2, PG, x4, x5), (x1, x2, x3, 1970, x5), (x1, x2, x3, x4, Comedy)}

The S set is unaffected by the second negative example. Since G is not a singleton set (i.e., it contains more than one concept description) a new training example (3) is considered. The third example is a positive one. Thus, any descriptions that are inconsistent with the third positive example are removed from the G set. Therefore, the new G set becomes:

G={(x1, x2, PG, x4, x5), (x1, x2, x3, x4, Comedy)}

The S set is then generalized to include the third positive example. This involves replacing constants with variables. The new S set becomes:

S={(USA, x2, PG, x4, Comedy)}

At this juncture, the S and G sets specify a version space which implies that the target concept may be as specific as, “a comedy movie made in USA with a PG rating” or as general as “any comedy movie with PG rating”.

However, since G is still not a singleton set, the fourth example, which is negative, is considered. The fourth example is a movie whose origin is Britain. The S set is unaffected, but the G set must be specialized to avoid covering the fourth negative example. The new G set is:

G={(USA, x2, PG, x4, x5), (USA, x2, x3, x4, Comedy)}

Once again, since G is not a singleton set, the fifth and final example, which is a positive one, is considered. Thus, any descriptions that are inconsistent with it are removed from the G set, leaving:

G={(USA, x2, x3, x4, Comedy)}

Next, the S set is generalized to include the fifth example:

S={(USA, x2, x3, x4, Comedy)}

After considering the five examples, S and G are both singletons, and both are identical, thus, the method has converged to a single concept description. This implies that the method has learned that the user likes movies made in the USA and of type comedy based on the above sample viewing history. Such a single concept description can be output at step 222 to a television recording device to instruct such a device to automatically record movies which fit the single concept description. As discussed above, the same procedure could be extended to include other kinds of television shows.

Those skilled in the art will appreciate a further advantage of the learning methods of the present invention, namely that they are least-commitment methods. That is, the version space is pruned as little as possible at each step. Thus even if all positive examples are movies made in USA, the learning methods of the present invention will not reject the possibility that the target concept may include movies of other origin, until it receives a negative example that forces the rejection. Furthermore, the version space approach can be applied to a wide variety of learning tasks and representation languages. For example, the learning method of the present invention can be extended to handle continuously valued features and hierarchical knowledge.

The learning methods of the present invention are particularly suited to be carried out by a computer software program, such computer software program preferably containing modules corresponding to the individual steps of the method. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for learning a concept description from an example set containing a plurality of positive and/or negative examples, the method comprising the steps of:
initializing a general set to contain a null concept description;
initializing a specific set to contain a concept description of a first positive example from the example set; and
making the specific set more general according to each additional positive example from the example set and making the general set more specific according to each additional negative example from the example set until the specific and general sets converge to a single concept description.

2. A method for learning a concept description from an example set containing a plurality of positive and/or negative examples, the method comprising the steps of:
(a) initializing a general set to contain a null concept description;
(b) initializing a specific set to contain a concept description of a first positive example from the example set;
(c) accepting a next example from the plurality of positive and/or negative examples;
if the next example is a positive example:
removing from the concept description of the general set any description that does not cover the next example; and
updating the concept description of the specific set to contain the most specific set of descriptions that covers both the next example and the concept description before it is updated;
(d) if the next example is a negative example:
removing from the concept description of the specific set any description that covers the next example; and
updating the concept description of the general set to contain the most general set of descriptions that do not cover the next example; and
(e) repeating steps (c) and (d) until either each of the specific and general sets contain a single concept description which is the same or until each of the specific and general sets contain a single concept description which is different.

3. The method of claim 2, wherein step (e) results in the single concept description which is the same and wherein the method further comprises the step of (f) outputting the single concept description which is the same.

4. The method of claim 2, wherein the plurality of positive and negative examples contain description regarding television programming of a viewer and the single concept description which is the same resulting from step (e) indicates a type of television programming the viewer likes.

5. The method of claim 2, wherein the plurality of positive and negative examples contain description regarding television programming of a viewer and the single concept description which is the same resulting from step (e) indicates a type of television programming the viewer likes, wherein step (f) comprises outputting the single concept description which is the same to a television recording device for automatically recording television programs which fit the single concept description.

6. A program storage device readable by machine, tangibly embodying a program of instructions executable by the machine to perform method steps for learning a concept description from an example set containing a plurality of positive and/or negative examples, the method comprising the steps of:
initializing a general set to contain a null concept description;
initializing a specific set to contain a concept description of a first positive example from the example set; and
making the specific set more general according to each additional positive example from the example set and making the general set more specific according to each additional negative example from the example set until the specific and general sets converge to a single concept description.

7. A program storage device readable by machine, tangibly embodying a program of instructions executable by the machine to perform method steps for learning a concept description from an example set containing a plurality of positive and/or negative examples, the method comprising the steps of:
(a) initializing a general set to contain a null concept description;
(b) initializing a specific set to contain a concept description of a first positive example from the example set;
(c) accepting a next example from the plurality of positive and/or negative examples;
if the next example is a positive example:
removing from the concept description of the general set any description that does not cover the next example; and
updating the concept description of the specific set to contain the most specific set of descriptions that covers both the next example and the concept description before it is updated;
(d) if the next example is a negative example:
removing from the concept description of the specific set any description that covers the next example; and
updating the concept description of the general set to contain the most general set of descriptions that do not cover the next example; and
(e) repeating steps (c) and (d) until either each of the specific and general sets contain a single concept description which is the same or until each of the specific and general sets contain a single concept description which is different.

8. The program storage device of claim 7, wherein step (e) results in the single concept description which is the same and wherein the method further comprises the step of (f) outputting the single concept description which is the same.

9. The program storage device of claim 7, wherein the plurality of positive and negative examples contain description regarding television programming of a viewer and the single concept description which is the same resulting from step (e) indicates a type of television programming the viewer likes.

10. The program storage device of claim 7, wherein the plurality of positive and negative examples contain description regarding television programming of a viewer and the single concept description which is the same resulting from step (e) indicates a type of television programming the viewer likes, wherein step (f) comprises outputting the single concept description which is the same to a television recording device for automatically recording television programs which fit the single concept description.

11. A computer program product embodied in a computer-readable medium for learning a concept description from an example set containing a plurality of positive and/or negative examples, the computer program product comprising:
computer readable program code means for initializing a general set to contain a null concept description;
computer readable program code means for initializing a specific set to contain a concept description of a first positive example from the example set; and
computer readable program code means for making the specific set more general according to each additional positive example from the example set and making the general set more specific according to each additional negative example from the example set until the specific and general sets converge to a single concept description.

12. A computer program product embodied in a computer-readable medium for learning a concept description from an example set containing a plurality of positive and/or negative examples, the computer program product comprising:
(a) computer readable program code means for initializing a general set to contain a null concept description;
(b) computer readable program code means for initializing a specific set to contain a concept description of a first positive example from the example set;
(c) computer readable program code means for accepting a next example from the plurality of positive and/or negative examples;
if the next example is a positive example:
computer readable program code means for removing from the concept description of the general set any description that does not cover the next example; and
computer readable program code means for updating the concept description of the specific set to contain the most specific set of descriptions that covers both the next example and the concept description before it is updated;
(d) if the next example is a negative example:
computer readable program code means for removing from the concept description of the specific set any description that covers the next example; and
computer readable program code means for updating the concept description of the general set to contain the most general set of descriptions that do not cover the next example; and
(e) computer readable program code means for repeating (c) and (d) until either each of the specific and general sets contain a single concept description which is the same or until each of the specific and general sets contain a single concept description which is different.

13. The computer program product of claim 12, wherein (e) results in the single concept description which is the same and wherein the computer program product further comprises (f) computer readable program code means for outputting the single concept description which is the same.

14. The computer program product of claim 12, wherein the plurality of positive and negative examples contain description regarding television programming of a viewer and the single concept description which is the same resulting from (e) indicates a type of television programming the viewer likes.

15. The computer program product of claim 12, wherein the plurality of positive and negative examples contain description regarding television programming of a viewer and the single concept description which is the same resulting from (e) indicates a type of television programming the viewer likes, wherein (f) comprises computer readable program code means for outputting the single concept description which is the same to a television recording device for automatically recording television programs which fit the single concept description.
